(19) United States
(12) Patent Application Publication
(10) Pub. No.: US 2014/0220935 A1
(43) Pub. Date: Aug. 7, 2014

(54) Methods And Systems For Injecting Wireless Messages in Cellular Communications Systems

(71) Applicant: SRC, INC., North Syracuse, NY (US)

(72) Inventors: Jonathan Morgan Peck, Liverpool, NY (US); Ruibing Wang, Clay, NY (US)

(73) Assignee: SRC, INC., North Syracuse, NY (US)

(21) Appl. No.: 14/175,332

(22) Filed: Feb. 7, 2014

Related U.S. Application Data
(60) Provisional application No. 61/761,844, filed on Feb. 7, 2013.

(51) Int. Cl. H04W 12/10; H04W 68/02

(52) U.S. Cl. CPC H04W 12/10; H04W 68/02
USPC 455/410

(57) ABSTRACT

Methods and systems for injecting a wireless message in a cellular communication system. The attacking system receives a synchronization waveform from a base station and synchronizes in time and frequency. The attacking system transmits the correct time and frequency, and also transmits one or more attack messages. The mobile transceiver receives the one or more attack messages and responds. The attacking system then transmits a first wireless message configured to alter a characteristic of a physical layer of the mobile station.

### CROSS-REFERENCE TO RELATED APPLICATIONS

This application claims priority to U.S. Provisional Patent Application Ser. No. 61/761,844, filed on Feb. 7, 2013, and entitled “Methods and Systems for Injecting Wireless Messages in Cellular Communication Systems,” the entire disclosure of which is incorporated herein by reference.

### BACKGROUND

The present invention relates to methods and systems for cellular communications systems and, more particularly, to replacing existing messages on the wireless interface of a cellular communication system.

Wireless message injection has been used, for example, in 802.11 WiFi networks. WiFi networks are asynchronous time division multiple access (“TDMA”) and messages that are injected require almost no synchronization for success. An example of this type of attack is Newstweek, a device used to manipulate news read by people who are utilizing wireless hotspots.

An “international mobile subscriber identity (“IMSI”) catcher” is a method for impersonating a global system for mobile communications (“GSM”) cellular network base station in order to send unauthenticated messages to a mobile station to collect identity information from it. IMSI catchers require full base station emulation. This requirement limits the capabilities of an IMSI catcher to send messages to mobile stations that decide to move off of the real GSM network and attach to the IMSI catcher.

Accordingly, there is a continued need for methods and systems for replacing existing messages on the wireless interface of a cellular communication system which do not, for example, require full base station emulation.

### BRIEF SUMMARY

According to one aspect, a method for injecting a wireless message in a cellular communication system, the method comprising the steps of: (i) providing an attacking system, wherein the attacking system comprises an attacking system transceiver and a processor; (ii) receiving by the attacking system transceiver a synchronization waveform from a base station; (iii) synchronizing the attacking system in time and frequency with the base station based on the received synchronization waveform; (iv) transmitting, by the attacking system transceiver, the correct time and frequency; (v) transmitting, by the attacking system transceiver, a plurality of attack messages; (vi) receiving, by the attacking system transceiver from a mobile transceiver, a response to one of the plurality of attack messages; and (vii) transmitting, by the attacking system transceiver, a first wireless message configured to alter a characteristic of a physical layer of the mobile station.

According to an embodiment, the attacking system modifies the transmitted correct time and frequency to account for potential propagation delay at the mobile station.

According to an embodiment, the step of synchronizing the attacking system in frequency with the base station comprises the step of detecting a frequency correction burst on a frequency correction channel transmitted by the base station.

According to an embodiment, the step of synchronizing the attacking system in time with the base station comprises the step of detecting a synchronization waveform transmitted by the base station.

According to an embodiment, the plurality of attack messages comprise a custom paging message.

According to an embodiment, the plurality of attack messages comprise an access granting message, and further wherein the plurality of attack messages are transmitted in response to detection of an access granting burst from the mobile transceiver.

According to an embodiment, the plurality of attack messages comprise an access granting message transmitted in response to a request from a mobile transceiver for a dedicated connection.

According to an embodiment, the plurality of attack messages comprise an initiation of an inbound call to the mobile transceiver.

According to an embodiment, the plurality of attack messages comprise an SMS message.

According to an aspect, a system configured to inject a wireless message in a cellular communication system, the system comprising: (i) a base station, the base station configured to transmit a synchronization waveform; (ii) a mobile device comprising a mobile device transceiver and configured to receive a synchronization waveform; (iii) an attacking device comprising an attacking device transceiver and a processor, wherein the attacking device transceiver is configured to receive the synchronization waveform from the base station, synchronize in time and frequency with the base station based on the received synchronization waveform, transmit the correct time and frequency and a plurality of attack messages, receive from the mobile device transceiver, a response to one of the plurality of attack messages; and transmitting a first wireless message configured to alter a characteristic of a physical layer of the mobile station.

According to an embodiment, the attacking system is further configured to modify the transmitted correct time and frequency to account for potential propagation delay at the mobile station.

According to an embodiment, the attacking system is further configured to detect a frequency correction burst on a frequency correction channel transmitted by the base station.

According to an embodiment, the attacking system is further configured to detect a synchronization burst on a synchronization channel transmitted by the base station.

According to an embodiment, the plurality of attack messages comprise a custom paging message.

According to an embodiment, the plurality of attack messages comprise an access granting message, and further wherein the plurality of attack messages are transmitted in response to detection of an access granting burst from the mobile transceiver.

According to an embodiment, the plurality of attack messages comprise an access granting message transmitted in response to a request from a mobile transceiver for a dedicated connection.

According to an embodiment, the plurality of attack messages comprise an initiation of an inbound call to the mobile transceiver.

According to an embodiment, the plurality of attack messages comprise an SMS message.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a method for injecting wireless messages in a cellular communication system, according to an embodiment;

FIG. 2 is a depiction of frequency correction burst structure according to an embodiment;

FIG. 3 is a graph of frequency response of frequency correction burst according to an embodiment;

FIG. 4 is a depiction of synchronization burst structure according to an embodiment;

FIG. 5 is a depiction of call flow for a mobile originated call according to an embodiment; and

FIG. 6 is a flowchart of a method for inserting a wireless message according to an embodiment.

### DETAILED DESCRIPTION

Methods and systems for injecting messages to a mobile station. For a successful message injection on a mobile station the attacking system must be properly synchronized in time and frequency to the serving base station. The attacking system can use the same synchronization waveforms broadcasted by the serving base station as the mobile station to synchronize to the network.

Once the attacking system is synchronized to the serving base station it can target victim mobile stations by transmitting the correct time and frequency. Depending on its geographical location with respect to that of the base station and mobile station, it may need to account for additional propagation delay at the victim mobile station. The attacking system can then send attacking messages which overpower the message coming from the base station.

The attacking system and victim mobile station enter into an attack loop where attack messages are sent from the attacking system to the victim mobile station. The victim mobile station is forced to respond to the messages and transmits them to the attacking system.

Through the injected message the attacking system can change the characteristics of the physical layer that the mobile station is operating on. This reduces or eliminates the interference that the attacking system faces from the base station.

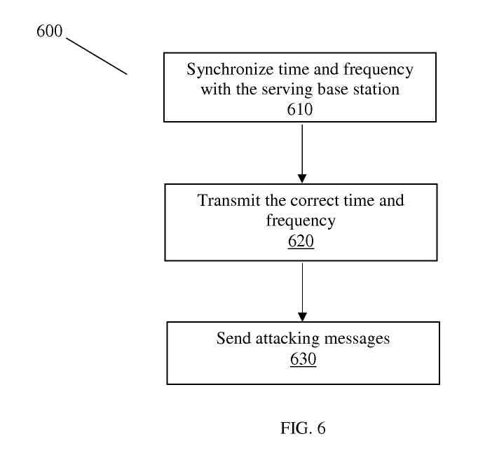

Referring now to the drawings, wherein like reference numerals refer to like parts throughout, there is seen in FIG. 6 a flowchart depicted a method 600 for injecting wireless messages in cellular communication systems according to an embodiment. At step 610, the attacking system is synchronized in time and frequency with the serving base station. The attacking system can use the same synchronization waveforms broadcasted by the serving base station to synchronize to the network as the mobile station.

At step 620, once the attacking system is synchronized to the serving base station, the attacking system can target victim mobile stations by transmitting the correct time and frequency. The attacking system must account for potential propagation delay at the victim mobile station. At 630, the attacking system can then send attacking messages which overpower the message coming from the base station.

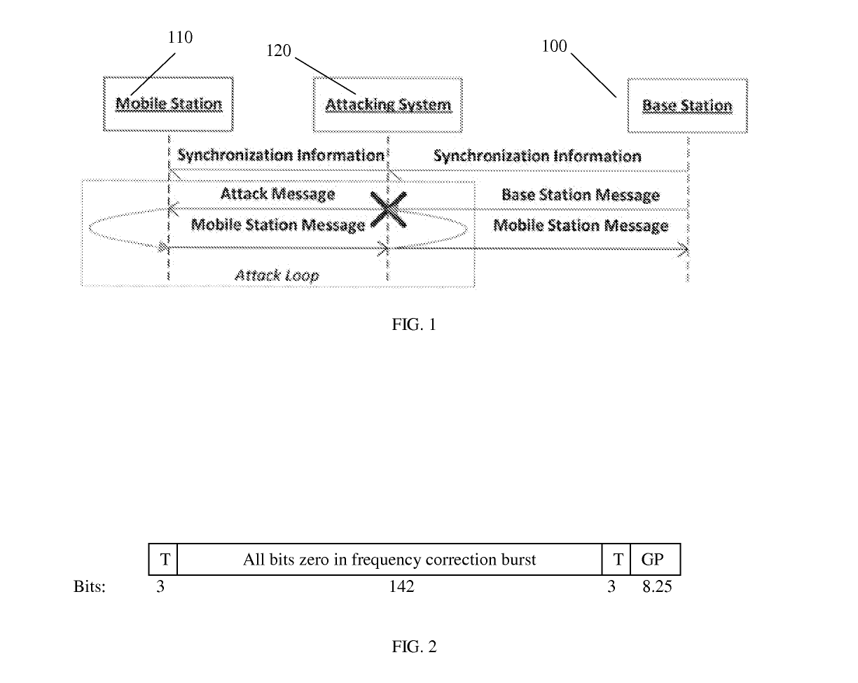

FIG. 1 is a representation of a wireless injection system according to an embodiment. The base station 100 can be designed or programmed to constantly, periodically, intermittently, or in response to a certain signal, time, or other event, broadcast synchronization waveforms across its area of coverage. Both the victim mobile station 110 and the attacking system 120 receive these synchronization waveforms and use them to synchronize in time and frequency to the base station. Using this synchronization, the attacking system can then overpower messages sent to the victim mobile station. The mobile station perceives these overpowered messages received as coming from the base station. The mobile station is forced to respond to these messages based on the cellular standard. Through the injected message the attacking system can change the characteristic of the physical later that the mobile station is operating on. This reduces or eliminates the interference that the attacking system faces from the base station.

Message injection can be applied to GSM, as well as other cellular technologies. Although the below description is provided in reference to GSM, it is not limited to GSM and other cellular technologies may be utilized.

### Frequency Synchronization

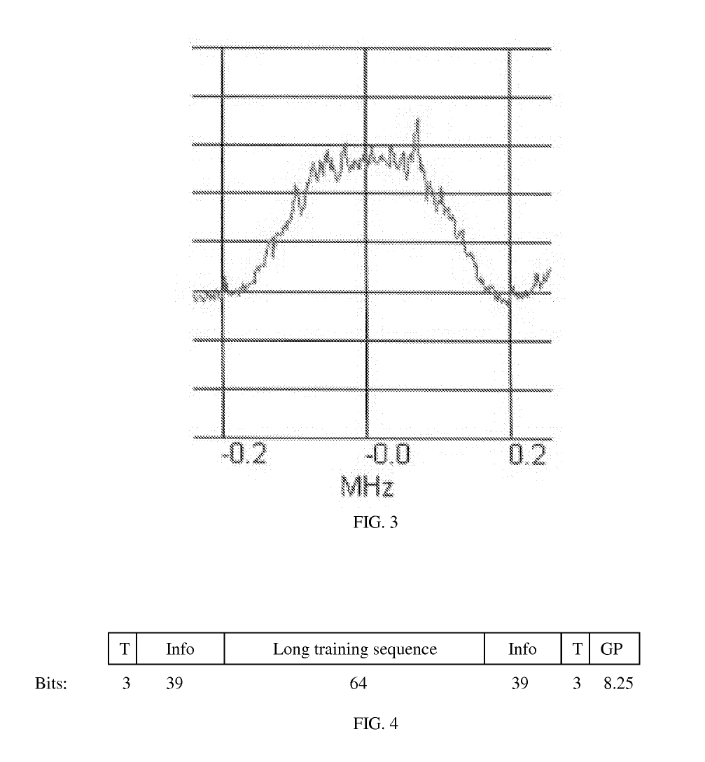

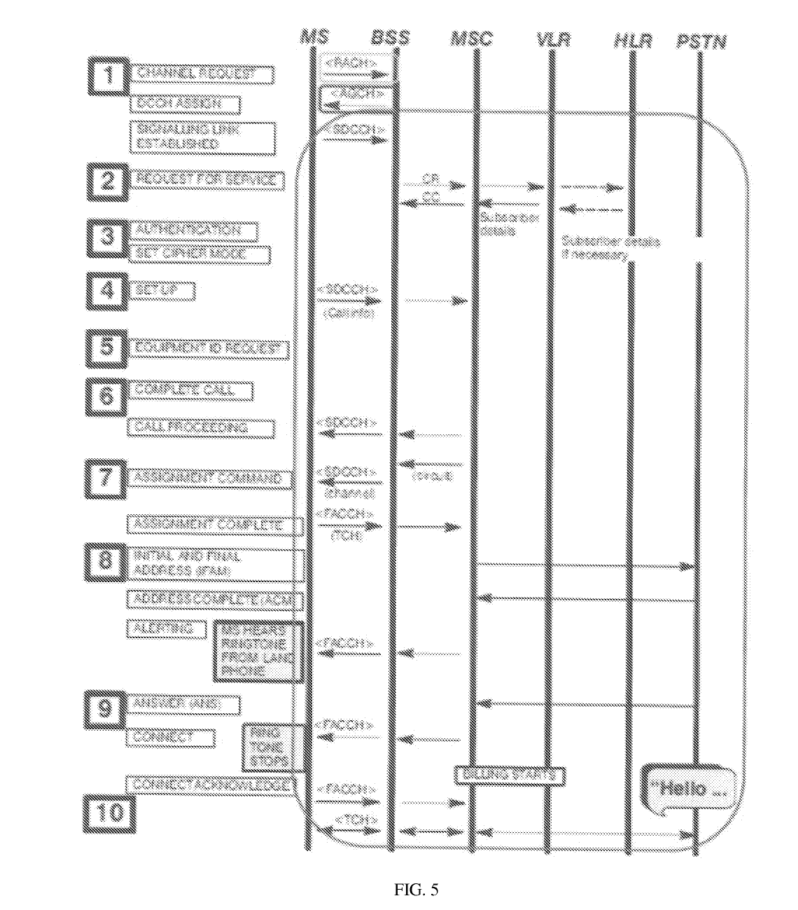

As shown in FIGS. 2 and 3, frequency synchronization is based on detection of the frequency correction bursts on the frequency correction channel (“FCCH”). According to one embodiment, the base transceiver station (“BTS”) transmits these bursts in timeslot 0 of frames 0, 10, 20, 30, and 40 in every 51 multiframe. The bursts may be, for example, specially coded bursts so that for 142 symbols they output a CW tone at a +67708.3 (13/48*1e6/4) Hz offset from the center of the absolute radio-frequency channel number (“ARFCN”) frequency.

While there are several ways to identify the tone, one implementation utilizes a normalized fast Fourier transform (“FFT”) power method to detect and analyze the received bursts. The algorithm breaks every received burst into two 71-symbol blocks for FFT. This allows at least one block in an adjacent timeslot to catch only the frequency correction symbols regardless of the synchronicity between the attacking system and BTS. Other methods are also possible.

According to an embodiment, the input block is then fed to the FFT library as a 128-point FFT using zero-padding to improve resolution and performance. The algorithm will find the interpolated peak frequency bin, normalize it based on the input block's RMS, and determine whether it is strong enough to be a valid FCCH burst.

### Time Synchronization

According to an embodiment, the time synchronization is based on detection of the synchronization bursts on the SCH. The BTS transmits these bursts in timeslot 0 of frames 1, 11, 21, 31, and 41 in every 51 multiframe. These bursts have a special extended training sequence code that is 64-bits in length. Its payload (once decoded) contains the cell's base station identity code (“BSIC”) and the frame's frame number.

Since the synchronization burst can appear halfway between two of the received bursts, the detection algorithm must operate on a contiguous, overlapping signal of at least 1.5 bursts to recover the entire synchronization burst. This means that the always patch in the at least half the burst from the previous burst whenever it is operating on a particular received burst. Afterwards, the current burst must be saved for the next burst. According to one embodiment an implementation saves and patches the whole burst.

One method of preventing the algorithm having to process every burst of every frame until the synchronization burst is detected is to utilize the fact that the synchronization burst always appears 51n+1 frames after the frequency correction burst with n=0,1,2,etc.

According to a preferred embodiment, the detection of the synchronization burst is achieved by cross-correlating the received signal against the extended training sequence code. The interpolated output peak value should then be normalized based on the input signal RMS value and threshold to determine validity.

This burst is then fed into a Viterbi decoder to obtain the payload and parity check the decoded bits. This allows the frame number and BSIC to be calculated. At this point, the algorithm has validated the synchronization burst and can calculate the delay (or advance) in frames, timeslots, and non-integer symbols. For example, supposing a synchronization burst is decoded as frame number 711522 and is located at the received uplink frame number 2607421, timeslot 0, and symbol 115.3574. After converting the received timing information to its downlink equivalent (i.e. uplink lags downlink by 3 timeslots) and minimizing the symbol delay, the algorithm interprets the BTS's frame number 711522, timeslot 0, and symbol 0 to be synchronized to the attacking system's frame number 2607421, timeslot 4, and symbol −41.6426. This means that there is a difference of −1895899 frames, −4 timeslots, and +41.6426 symbols that must be corrected.

### Persistence Mode

A persistent time synchronization mode can be implemented to handle timing walking by measuring and persistently accounting for this residual error. It first measures the error rate per frame by measuring across multiple super frames. After synchronization and reverting the receive frequency to the uplink, it can correct for the error based on the error rate.

For example, supposing the residual error after synchronization is 0.4 symbols and there is an error rate of −0.01 symbols per frame, after 91 frames, there will be a predicted error of −0.51 symbols, thereby prompting the algorithm to apply a single symbol delay and change the new error to 0.49 symbols.

An alternative method of determining the error rate is to calculate it directly based on the frequency error. Since frequency error and symbol-rate error both directly stem from an error in the local oscillator, it should be possible to calculate one from the other based on some model.

### Attack Messages and Connections

Paging Injection—A technique according to one embodiment overrides the paging channel of the BTS to send out a custom paging message to all the mobile stations camped on the cell. This message forces a particular mobile station to transmit a random access burst on the uplink frequency associated with the cell. This is the first step some of the other techniques described in this document.

Mobile Originated Call (“MOC”) Hijack—A technique according to one embodiment is designed to allow the attacking system to take control of all outbound voice calls from the MS. Both the attacking system and BTS should receive the access granting burst from the MS and send down an access granting message. If the attacking system can overpower the BTS, it will have successfully hijacked the dedicated connection. However, MS does not know that it has established a dedicated connection to the attacking system instead of the BTS.

The call flow figure provided above that the trigger is based on the access burst, which makes this a technique that must initiated by the mobile user. However, it allows the attacking system to perform this technique without knowing the mobile identity of the handset.

Mobile Terminated Call Hijack—A technique according to one embodiment is designed to allow the attacking system to take control of all inbound voice calls from BTS to the MS. It is very similar to the MOC hijack technique. When someone calls the handset from a landline or another handset, the BTS will page the MS and cause the MS to send a random access burst to request a dedicated connection. The attacking system acts as if it was a base station expecting a paging response.

Mobile Terminated Call injection—A technique according to one embodiment is designed to allow the attacking system to initiate an inbound voice call to the MS and hijack the resulting call. It is the same as the MTC hijack except the attacking system sends the paging message. It requires the attacking system to know the mobile identity of the handset, which can be revealed through a number of other attacking system techniques.

Mobile Terminated Special Hijack/Injection—A technique according to one embodiment is designed to allow the attacking system to initiate a special (non-voice) call to the MS and hijack the resulting call. This is a special dedicated connection that is invisible to the user (i.e. cannot be ignored or denied). It allows for the transfer of any layer 3 messages to the mobile station.

Mobile Originated Hijack—A technique according to one embodiment is designed to allow the attacking system to hijack all outbound SMS messages from the MS.

Mobile Terminated Injection—A technique according to one embodiment is designed to allow the attacking system to deliver its own inbound SMS message to the MS. If the attacking system knows the IMSI or TMSI of the handset, it will be able to initiate other services such as SMS message delivery. This allows the attacking system to send a text message to the handset.

System Parameter Injection—In the same way the attacking system can inject access granting and paging messages on the CCCH blocks, there is no reason why it cannot injection system information messages on the BCCH blocks. It should be able to inject any and all messages. It should also expect the handset to react in a timely manner, as the specification forces the handset to read the system information of the serving cell every 30 second.

Modification of the system type 2 message allows the attacking system to control cell reselection via control of the BCCH neighbor cell list. For example, it should allow the attacking system to injection a message with an empty list to ensure the handset cannot jump to another cell.

Modification of the system type 3 message allows the attacking system to control the LAI, cell selection parameter, and control channel description. This allows the BTS to appear to be in a different LAI and force a location update. It also allows the cell selection parameter to be tweaked to control how attractive the BTS is for cell selection. The T3212 timer embedded in the control channel description allows the attacking system to maximize the frequency of periodic location updates.

Although the present invention has been described in connection with a preferred embodiment, it should be understood that modifications, alterations, and additions can be made to the invention without departing from the scope of the invention as defined by the claims.

What is claimed is:

1. A method for injecting a wireless message in a cellular communication system, the method comprising the steps of:
providing an attacking system, wherein the attacking system comprises an attacking system transceiver and a processor;
receiving by the attacking system transceiver a synchronization waveform from a base station;
synchronizing the attacking system in time and frequency with the base station based on the received synchronization waveform;
synchronizing the attacking system in identity and configuration with the base station based on the received broadcast messages;
transmitting, by the attacking system transceiver, the correct time and frequency;
transmitting, by the attacking system transceiver, a plurality of attack messages;
receiving, by the attacking system transceiver from a mobile transceiver, a response to one of the plurality of attack messages; and
transmitting, by the attacking system transceiver, a first wireless message configured to alter a characteristic of a physical layer of the mobile station.

2. The method of claim 1, wherein the attacking system modifies the transmitted correct time and frequency to account for potential propagation delay at the mobile station.

3. The method of claim 1, wherein the step of synchronizing the attacking system in frequency with the base station comprises the step of detecting a frequency correction burst on a frequency correction channel transmitted by the base station.

4. The method of claim 1, wherein the step of synchronizing the attacking system in time with the base station comprises the step of detecting, demodulating, and decoding a synchronization waveform transmitted by the base station.

5. The method of claim 1, wherein the step of synchronizing the attacking system in identity and configuration with the base station comprises the step of detecting, demodulating, and decoding system information messages on broadcast control channels transmitted by the base station.

6. The method of claim 1, wherein the plurality of attack messages comprise a custom system information message transmitted to alter the behavior of the mobile transceiver in response to modified identity or configuration from the base station.

7. The method of claim 1, wherein the plurality of attack messages comprise a custom paging message.

8. The method of claim 1, wherein the plurality of attack messages comprise an access granting message, and further wherein the plurality of attack messages are transmitted in response to detection of an access granting burst from the mobile transceiver.

9. The method of claim 1, wherein the plurality of attack messages comprise an access granting message transmitted in response to a request from a mobile transceiver for a dedicated connection.

10. The method of claim 1, wherein the response to the plurality of attack messages comprise an interception of an international mobile subscriber identity from the mobile transceiver.

11. The method of claim 1, wherein the response to the plurality of attack messages comprise an interception of an international mobile state equipment identity from the mobile transceiver.

12. The method of claim 1, wherein the plurality of attack messages comprise an initiation of an inbound call to the mobile transceiver.

13. The method of claim 1, wherein the response to the plurality of attack messages comprise an interception, which can be bypassed based on call type, of an outbound call from the mobile transceiver.

14. The method of claim 1, wherein the plurality of attack messages comprise an initiation of a custom SMS message to the mobile transceiver.

15. The method of claim 1, wherein the response to the plurality of attack messages comprise an interception of an outbound SMS message form the mobile transceiver.

16. A system configured to inject a wireless message in a cellular communication system, the system comprising:
a base station, the base station configured to transmit a synchronization waveform;
a mobile device comprising a mobile device transceiver and configured to receive a synchronization waveform;
an attacking device comprising an attacking device transceiver and a processor, wherein the attacking device transceiver is configured to receive the synchronization waveform from the base station, synchronize in time and frequency with the base station based on the received synchronization waveform, transmit the correct time and frequency and a plurality of attack messages, receive from the mobile device transceiver, a response to one of the plurality of attack messages; and transmitting a first wireless message configured to alter a characteristic of a physical layer of the mobile station.

17. The system of claim 16, wherein the attacking system is further configured to modify the transmitted correct time and frequency to account for potential propagation delay at the mobile station.

18. The system of claim 16, wherein the attacking system is further configured to detect a frequency correction burst on a frequency correction channel transmitted by the base station.

19. The system of claim 16, wherein the attacking system is further configured to detect a synchronization burst on a synchronization channel transmitted by the base station.

20. The system of claim 16, wherein the plurality of attack messages comprise a custom paging message.

21. The system of claim 16, wherein the plurality of attack messages comprise an access granting message, and further wherein the plurality of attack messages are transmitted in response to detection of an access granting burst from the mobile transceiver.

22. The system of claim 16, wherein the plurality of attack messages comprise an access granting message transmitted in response to a request from a mobile transceiver for a dedicated connection.

23. The system of claim 16, wherein the plurality of attack messages comprise an initiation of an inbound call to the mobile transceiver.

24. The system of claim 16, wherein the plurality of attack messages comprise an SMS message.
